(19) United States
(12) Patent Application Publication
(10) Pub. No.: US 2002/0077851 A1
(43) Pub. Date: Jun. 20, 2002

(54) Method of watching a person to be diagnosed/treated in time and system thereof

(75) Inventor: Hui-Wen Cheng, Taipei (TW)

Correspondence Address: BACON &THOMAS, 4th Floor, 625 Slaters Lane, Alexandria, VA, 22314, US

(73) Assignee: TrustMed.Com Corp., Taipei (TW)

(21) Appl. No.: 09/782,000

(22) Filed: Feb. 14, 2001

(30) Foreign Application Priority Data
Oct. 31, 2000 (TW) 89122931

(51) Int. Cl. G06F 17/60

(52) U.S. Cl. 705/2

(57) ABSTRACT

A system of watching a person to be diagnosed/treated in time includes a database server; a network server; and a communication devices; wherein the database server is built-in with a database of vaccination and with a software, so that a) the database server determines time for a person to be diagnosed/treated according to medical criteria on his/her medical data recorded in the database; b) said network server and said communication means notify said person to be diagnosed/treated according to the determined time in advance the determined time; and c) said network server and said communication means remind said person of the diagnosis/treatment if said network server should fail to receive a confirmation of his/her diagnosis/treatment after the determined time.

### FIELD OF THE INVENTION

The present invention relates to a method and a system of watching a person to be diagnosed/treated in time.

### BACKGROUND OF THE INVENTION

After receiving treatments from doctors, certain patients should continue their treatments. However, due to lack of an adequate reminding system, the hospitals or doctors are unable to remind the patients of their appointments in advance or after the patients miss their appointments. Therefore, certain patients suffer a higher risk of seizure or death from cardiovascular diseases when they miss their appointments.

### SUMMARY OF THE INVENTION

The present invention provides a method and a system of and watching a person to be diagnosed/treated in time to solve the above-mentioned problems long existed in the medical field.

In one aspect of the present invention, a method of watching a person to be diagnosed/treated in time according to the present invention is carried out via a network.

In another aspect of the present invention, a system of watching a person to be diagnosed/treated in time according to the present invention works cooperatively with a network.

### BRIEF DESCRIPTION OF THE DRAWINGS

FIG. 1 is a flowchart showing a method of watching a person to be diagnosed/treated in time according to a first embodiment of the present invention.

FIG. 2 is a schematic block diagram showing a system of watching a person to be diagnosed/treated in time according to the present invention.

FIG. 3 is a flowchart showing a method of periodically and constantly recording and watching a person's blood pressure according to a second embodiment of the present invention.

FIG. 4 is a flowchart comprising steps for deciding whether a client is a new hypertensive patient or not based on the blood pressure data.

FIG. 5 is a flowchart showing a method of watching a child to be vaccinated in time according to a third embodiment of the present invention.

FIG. 6 is a flowchart showing a method of periodically and constantly recording and watching a person's blood sugar according to a fourth embodiment of the present invention.

### DETAILED DESCRIPTION OF THE INVENTION

The present invention discloses a method of watching a person to be diagnosed/treated in time comprising the following steps carried out in a computer system:

a) determining time for a person to be diagnosed/treated according to medical criteria on his/her medical data recorded in a medical database of persons;

b) notifying said person to be diagnosed/treated according to the determined time in advance the determined time;

c) reminding said person of the determined time if said computer system should fail to receive a confirmation of said person's diagnosis/treatment after the determined time; and

d) entering diagnosis/treatment data of said person into the medical database of persons, if said computer system receives the confirmation.

Preferably, said reminding is once per day.

Preferably, said notifying or said reminding step adopt a WAP system.

The present invention also discloses a system of watching a person to be diagnosed/treated in time comprising:

a database server;

a network server; and

communication means;

wherein said database server is built-in with a medical database and with a software, so that

A) said database server determines time for a person to be diagnosed/treated according to his/her medical data recorded in said medical database;

B) said network server and said communication means notify said person to be diagnosed/treated according to the determined time in advance the determined time; and

C) said network server and said communication means remind said person of the determined time if said network server should fail to receive a confirmation of said person's diagnosis/treatment after the determined time.

The database server used in the system of the present invention can be any known database servers.

The network server can be any known network servers, and said communication means can adopt any known communication means, preferably wireless communication means, more preferably a WAP system.

Said determination can be a regular determination or a random determination. Preferably, the determination is carried out after each recordal of the latest diagnosis/treatment in order to save the time spent on the determination.

The content of notification can be a simple date of the diagnosis/treatment, or can be added with other contents, such as medical common sense/knowledge/information related to the diagnosis/treatment.

Preferably, the diagnosis/treatment to be applied to the person is health examination, and the medical database is a database of health examination data.

In one aspect of the present invention, the diagnosis/treatment to be applied to the person is a blood pressure measurement, the medical database is a blood pressure database, and said medical criteria for determining time for blood pressure measurement are:

once per two years if the blood pressure<130/85;

once per year if 130/85≦the blood pressure<140/90;

once per two months if 140/90≦the blood pressure<160/100;

once per month if 160/100≦the blood pressure<180/110; and

once per two weeks if the blood pressure≧180/110.

The blood pressure database contains data of a hypertensive or a potential hypertensive patient, that should be recorded by a medical practitioner, e.g. name (or ID number, such as citizen's ID number, number of registration card of a hospital), data of blood pressure, etc., preferably may include further detailed information of the patient, e.g. habits of living, and risk factors that might cause hypertension, e.g. smoking, high blood-lipid, diabetes, family history of high blood pressure, personal history of high blood pressure, personal history of heart disease, history of kidney disease, etc.

In another aspect of the present invention, the diagnosis/treatment to be applied to the person is vaccination, and the medical database is a vaccination database. Preferably, said vaccination database contains data related to Hepatitis B vaccine; Diphtheria, tetanus toxoids and pertussis mixed vaccine; Poliovirus vaccine; or Japanese encephalitis vaccine. Preferably, said medical criteria for determining time for vaccination are timetable recognized by the medical profession.

The vaccination database contains data of a child or a person that should be recorded by a medical practitioner, e.g. name (or ID number, such as citizen's ID number, number of registration card of a hospital), data of vaccination, etc.

The medical criteria for determining the time for a child to be vaccinated can also be a doctor's subjective judgement, or according to the vaccination timetable recognized by the medical profession with the doctor's adjustment.

A typical child's vaccination timetable for Hepatitis B vaccine; Diphtheria, tetanus toxoids and pertussis mixed vaccine; Poliovirus vaccine; or Japanese encephalitis vaccine recognized by the medical profession can be programmed as follows:

The following four options will appear when a computer program is executed:

Hepatitis B vaccine

Diphtheria, tetanus toxoids and pertussis mixed vaccine

Poliovirus vaccine

Japanese encephalitis vaccine

I. Select the “Hepatitis B vaccine” option, the following options will appear:

First dose;

Second dose;

Third dose;

Fourth dose.

1) Select the “first dose” option, then (a) the following messages will appear “injection in the first week after birth”, and “Please enter the date of injection of the first dose” (default being the current date); (b) schedule date of injection of the second dose (automatic calculation: date of injection of the first dose plus four weeks), schedule date of injection of the third dose (automatic calculation: date of injection of the second dose plus four weeks), and schedule date of injection of the fourth dose (automatic calculation: date of injection of the third dose plus 43 weeks), when “the date of injection of the first dose” is entered and sent; and (c) notify the schedule dates through e-mail or a Wireless Application Protocol (WAP) system.

2) Select the “second dose” option, then (a) the following messages will appear “injection in the fifth week after birth”, and “Please enter the date of injection of the second dose”; (b) schedule date of injection of the third dose (automatic calculation: date of injection of the second dose plus four weeks), and schedule date of injection of the fourth dose (automatic calculation: date of injection of the third dose plus 43 weeks), when “the date of injection of the second dose” is entered and sent; and (c) notify the schedule dates through e-mail or a Wireless Application Protocol (WAP) system.

3) Select the “third dose” option, then (a) the following messages will appear “injection in the ninth week after birth”, and “Please enter the date of injection of the third dose”; (b) schedule date of injection of the fourth dose (automatic calculation: date of injection of the third dose plus 43 weeks), when “the date of injection of the third dose” is entered and sent; and (c) notify the schedule date through e-mail or a Wireless Application Protocol (WAP) system.

4) Select the “fourth dose” option, then (a) the following messages will appear “injection in the twelfth month after birth”, and “Please enter the date of injection of the fourth dose”.

II. Select the “Diphtheria, tetanus toxoids and pertussis mixed vaccine” option, the following options will appear:

First dose;

Second dose;

Third dose;

1) Select the “first dose” option, then (a) the following messages will appear “injection two months after birth”, and “Please enter the date of injection of the first dose”; (b) schedule date of injection of the second dose (automatic calculation: date of injection of the first dose plus two months), and schedule date of injection of the third dose (automatic calculation: date of injection of the second dose plus two months), when “the date of injection of the first dose” is entered and sent; and (c) notify the schedule dates through e-mail or a Wireless Application Protocol (WAP) system.

2) Select the “second dose” option, then (a) the following messages will appear “injection fourth months after birth”, and “Please enter the date of injection of the second dose”; (b) schedule date of injection of the third dose (automatic calculation: date of injection of the second dose plus two months), when “the date of injection of the second dose” is entered and sent; and (c) notify the schedule date through e-mail or a Wireless Application Protocol (WAP) system.

3) Select the “third dose” option, then (a) the following messages will appear “injection six months after birth and an additional injection one year after the third dose”, and “Please enter the date of injection of the third dose” (b) schedule date of injection of the additional dose (automatic calculation: date of injection of the third dose plus twelve months), when “the date of injection of the third dose” is entered and sent; and (c) notify the schedule date through e-mail or a Wireless Application Protocol (WAP) system.

III. Select the “poliovirus vaccine” option, the following options will appear:

First dose;

Second dose;

Third dose;

1) Select the “first dose” option, then (a) the following messages will appear “injection two months after birth”, and “Please enter the date of injection of the first dose”; (b) schedule date of injection of the second dose (automatic calculation: date of injection of the first dose plus two months), and schedule date of injection of the third dose (automatic calculation: date of injection of the second dose plus two months), when “the date of injection of the first dose” is entered and sent; and (c) notify the schedule dates through e-mail or a Wireless Application Protocol (WAP) system.

2) Select the “second dose” option, then (a) the following messages will appear “injection fourth months after birth”, and “Please enter the date of injection of the second dose”; (b) schedule date of injection of the third dose (automatic calculation: date of injection of the second dose plus two months), when “the date of injection of the second dose” is entered and sent; and (c) notify the schedule date through e-mail or a Wireless Application Protocol (WAP) system.

3) Select the “third dose” option, then (a) the following messages will appear “injection six months after birth, another injection one year after the third dose, and a further injection in the first grade of the elemental school”, and “Please enter the date of injection of the third dose” (b) schedule date of the another injection (automatic calculation: date of injection of the third dose plus twelve months), and schedule date of the further injection, when “the date of injection of the third dose” is entered and sent; and (c) notify the schedule date through e-mail or a Wireless Application Protocol (WAP) system.

IV. Select the “Japanese encephalitis vaccine” option, the following options will appear:

First dose;

Second dose;

Third dose;

1) Select the “first dose” option, then (a) the following messages will appear “injection 15 months after birth”, and “Please enter the date of injection of the first dose”; (b) schedule date of injection of the second dose (automatic calculation: date of injection of the first dose plus two weeks), and schedule date of injection of the third dose (automatic calculation: date of injection of the second dose plus 12 months), when “the date of injection of the first dose” is entered and sent; and (c) notify the schedule dates through e-mail or a Wireless Application Protocol (WAP) system.

2) Select the “second dose” option, then (a) the following messages will appear “injection 15 months and two weeks after birth”, and “Please enter the date of injection of the second dose”; (b) schedule date of injection of the third dose (automatic calculation: date of injection of the second dose plus 12 months), when “the date of injection of the second dose” is entered and sent; and (c) notify the schedule date through e-mail or a Wireless Application Protocol (WAP) system.

3) Select the “third dose” option, then (a) the following messages will appear “injection 27 months and two weeks after birth and an additional injection in the first grade of the elemental school”, and “Please enter the date of injection of the third dose” (b) schedule date of injection of the additional injection, when “the date of injection of the third dose” is entered and sent; and (c) notify the schedule date through e-mail or a Wireless Application Protocol (WAP) system.

In still another aspect of the present invention, the diagnosis/treatment to be applied to the person is a blood sugar measurement, the medical database is a blood sugar database, and said medical criteria for determining time for blood sugar measurement doctor's subjective judgement or according to the general regulation of once per month for a diabetic patient.

The blood sugar database contains data of a diabetic or a potential diabetic patient, that should be recorded by a medical practitioner, e.g. name (or ID number, such as citizen's ID number, number of registration card of a hospital), data of blood sugar, etc., preferably may include further detailed information of the patient, e.g. habits of living, risk factors that might cause diabetes, etc.

The diagnostic of blood sugar can be carried out according to the subjective judgement by a doctor, or from a specific checklist (as shown in Table 1).

TABLE 1

| | Unit | Normal | Acceptable | Poor |
|---|---|---|---|---|
| Blood sugar before meal | mg/100 ml | 70-110 | ≦140 | >140 |
| (about 30 minutes before | | | | |
| meal) | | | | |
| Blood sugar after meal | mg/100 ml | 70-140 | ≦180 | >180 |
| (about 2 hours after | | | | |
| meal) | | | | |

A diagnostic standard proposed by the American Diabetes Association: a diabetes exists when the blood sugar exceeds 126 mg/100 ml on an empty stomach, and the value is normal when the blood sugar is below 110 mg/100 ml on an empty stomach.

The above-mentioned notification or reminder can be carried out by using any known methods of notification or reminder, such as notification/reminder by a conventional telephone, notification/reminder through a network (e.g. e-mail, mobile phone, cable telephone, etc.) Preferably, the notification/reminder is carried out through a network. More preferably, the notification/reminder is carried out by using a mobile phone through a network. Most preferably, the notification/reminder is carried out by a mobile phone system using WAP (Wireless Application Protocol).

The above-mentioned reminder is based on whether a confirmation of a person's diagnosis/treatment is received within a certain period of time after receiving a notification (or a previous reminder). Of course, the number of times of reminding can also be set to a default value, e.g. stop reminding after a specified number of reminders.

The term “in advance” varies according to the need. For example, a person reserving a clinical visit requires only slightly earlier (a few days or even earlier that day); a person without a reservation requires a much earlier notification for the person to register or make a reservation.

The method and the system of watching a person to be diagnosed/treated in time according to the present invention is not limited to be used by a hospital, and can be used by a medical research organization or an organization in the medical profession having a power of public reputation, and/or a subsidiary thereof.

In order to further elaborate the present invention, preferred embodiments are illustrated together with figures. However, the scope of the present invention is not limited by the preferred embodiments or figures.

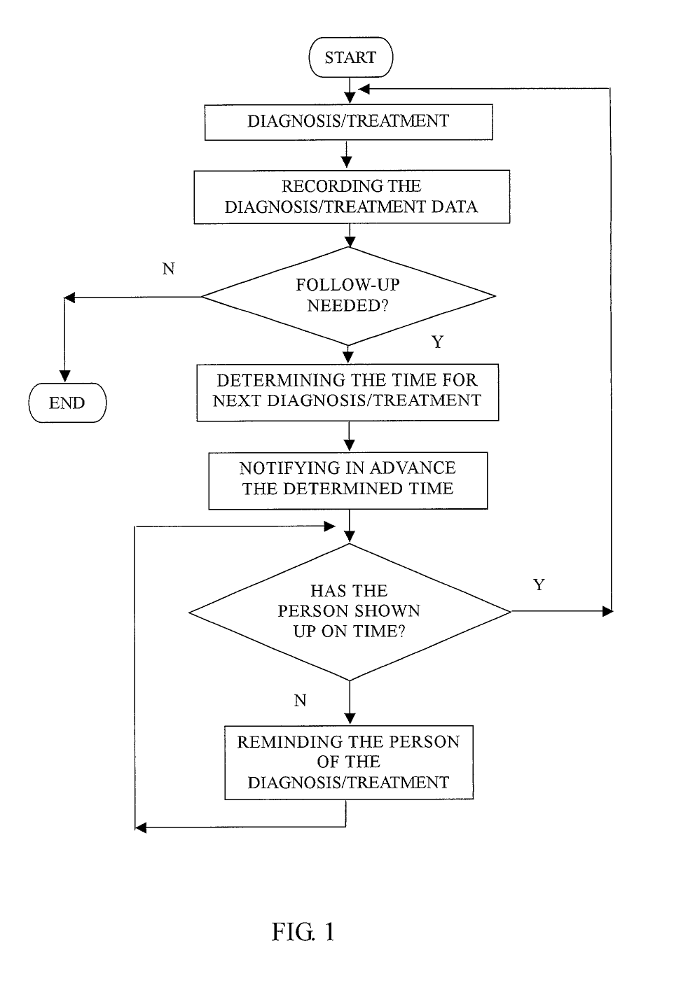

FIG. 1 is a schematic flowchart of a method of watching a person to be diagnosed/treated in time implemented in a hospital. The method comprises diagnosing/treating a person; recording the diagnosis/treatment data; determining whether a follow-up diagnosis/treatment is needed; no notification is required, if the answer is “NO”; determining the time for next diagnosis/treatment, if the answer is “YES”; notifying the person of the diagnosis/treatment in advance the determined time; checking whether the person has shown up according to the determined time; reminding the person to be diagnosed/treated, if the answer is “NO”; and returning to the first step, if the answer is “YES”.

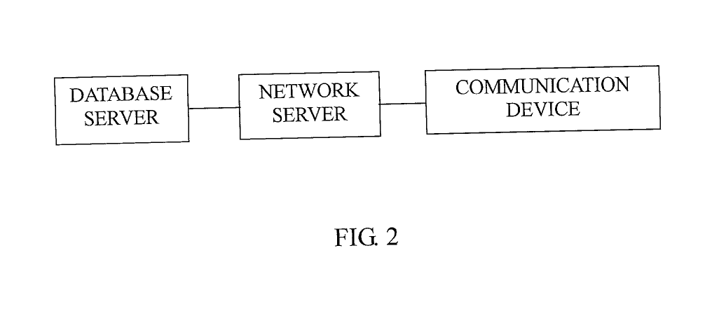

FIG. 2 is a block diagram of a system of watching a person to be diagnosed/treated in time for use in a hospital, in which the database server uses a computer and a UNIX system, the network server uses a computer and a UNIX system, and the communication device uses a WAP system. The database server and the communication device are connected to the network server.

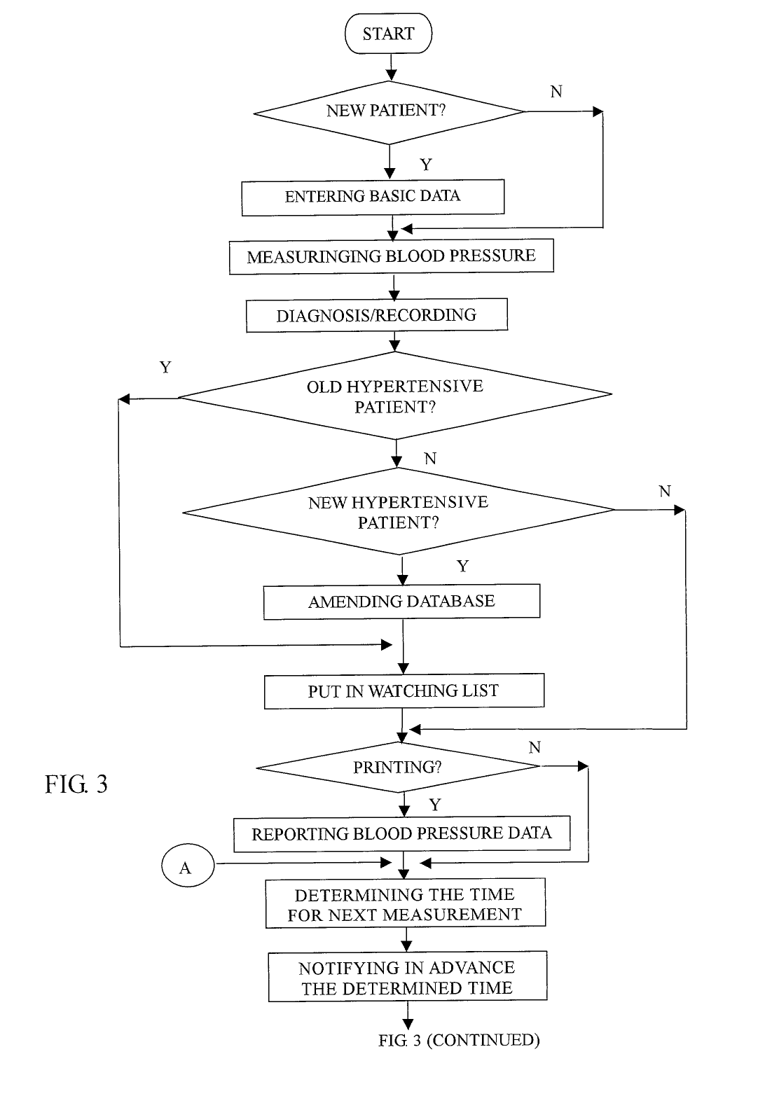

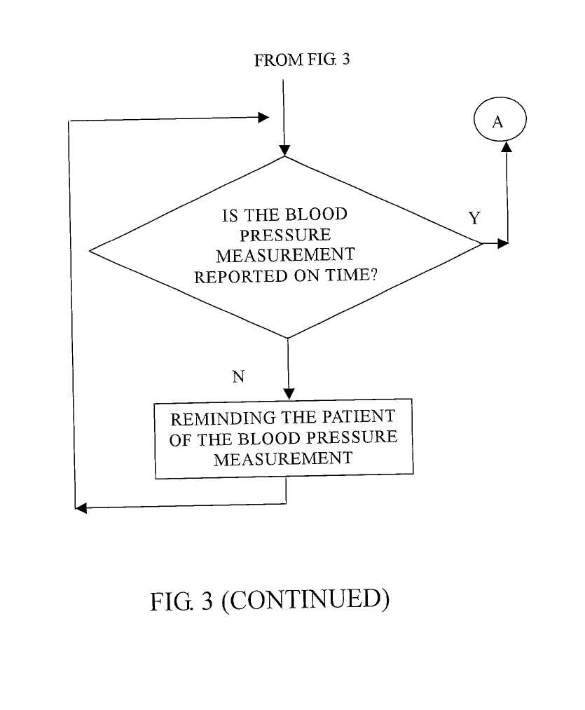

In another embodiment, the method of the present invention includes setting up the blood pressure database and watching the blood pressure of hypertensive patients. As shown in FIG. 3, the method of this embodiment contains three determination formulas. “whether this is a new client (patient)?”, “whether this is an old hypertensive patient?”, and “whether this is a new hypertensive patient?”. The method according to this embodiment first decides whether a person taking a blood pressure measurement is a new client (patient) or not. A new patient is required to enter the basic data before the measurement. The blood pressure measurement is then recorded and is used for diagnosis. The status of the client will be checked to decide whether the client is an old hypertensive patient or not. If the client is not an old hypertensive patient, he/she will be decided as a new hypertensive patient or not based on the blood pressure data. If the answer is “Yes”, the status of the client will be changed to a hypertensive patient and put into the watching list. If the answer is “No”, the client will not be put into the watching list. If the client is an old hypertensive patient, he/she will be put in the watching list directly. The method will then decide whether the blood pressure data of the client is to be printed, so that the client can receive the printing report which may include the historical data of blood pressure, the trend diagram of blood pressure, etc. The steps thereafter comprise determining the time for next measurement; notifying the patient in advance the determined time; checking whether the patient reports his/her blood pressure according to the determined time; reminding the patient of the blood pressure measurement, if the answer is “No”, and returning to the step of determining the time for next measurement, if the answer is “Yes”.

The printing report may further include the data listed in Table 1 and the suggestions for controlling the hypertension listed in Table 2.

TABLE 2

| Blood pressure | Group A** | Group B** | Group C** |
|---|---|---|---|
| 130/85 ≦ BP < | Adjusting life | Adjusting life | Should receive |
| 140/90* | style | style | medical |
| | | | treatment |
| 140/90 ≦ BP < | Adjusting life | Adjusting life | Should receive |
| 160/100 | style for a year | style for six | medical |
| | | months | treatment |
| BP ≧ 160/100 | Should receive | Should receive | Should receive |
| | medical | medical | medical |
| | treatment | treatment | treatment |

*Same as Table 1.
**Group A: no major risk factors, no damaged target organs or clinical cardiovascular diseases; Group B: at least one major risk factor, no diabetes, no damaged target organs or clinical cardiovascular diseases; and Group C: has damaged target organ(s) or clinical cardiovascular disease(s) or diabetes, major risk factors are optional.

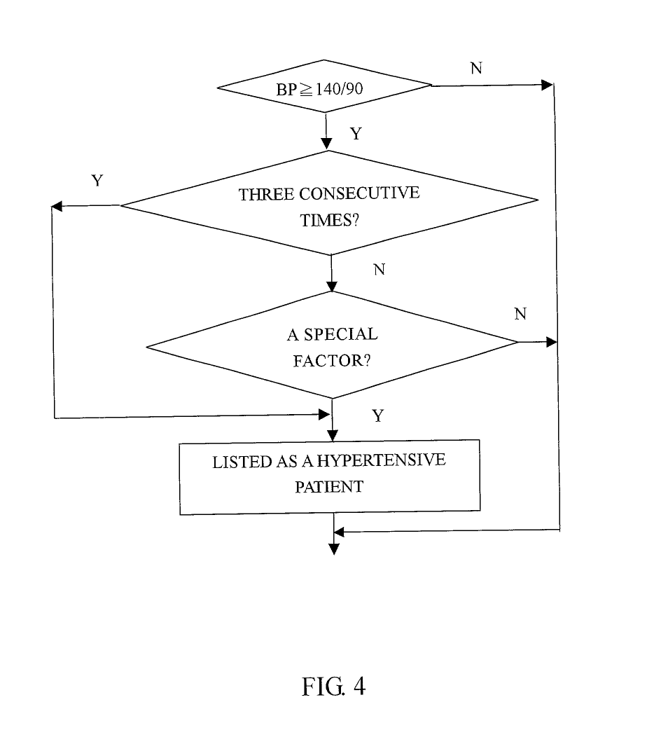

In FIG. 3, the step of deciding whether the client is a new hypertensive patient or not based on the blood pressure data may comprise the sub-steps shown in FIG. 4: checking whether the blood pressure of the client is equal to or greater than 140/90; further checking whether the blood pressure of the client is equal to or greater than 140/90 for three consecutive measurements when the answer is “Yes”; and checking whether there is a special factor to be considered, e.g. cardiovascular disease, if only one or two measurements of blood pressure are higher than 140/90. The client will be listed as a hypertensive patient if three consecutive measurements of blood pressure are higher than 140/90, or if one to two measurements of blood pressure are higher than 140/90 with the special factor.

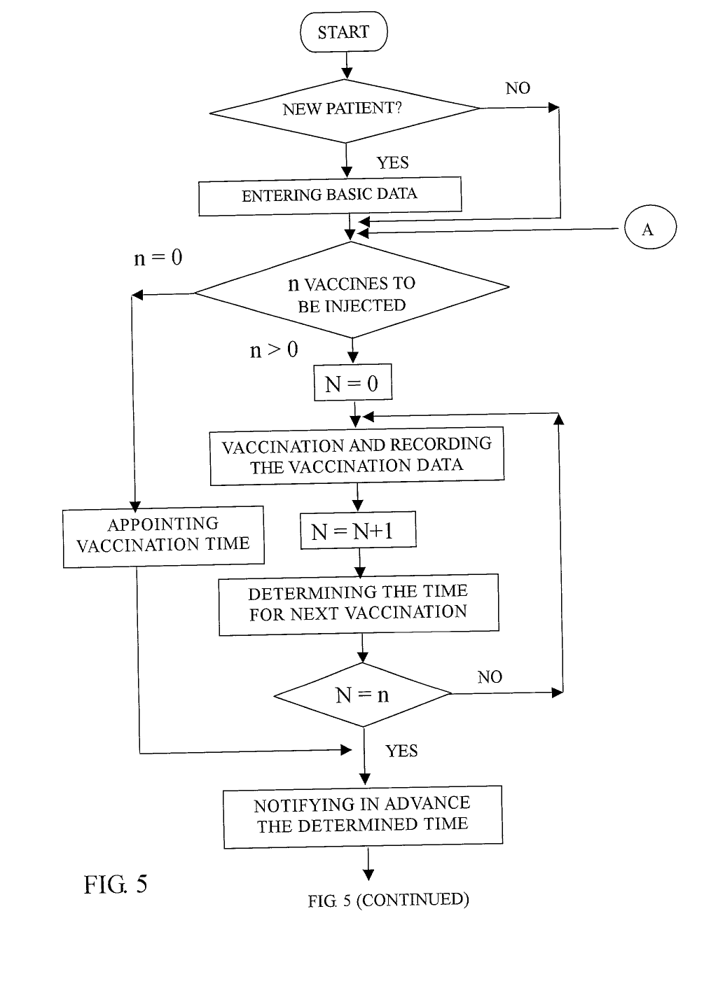

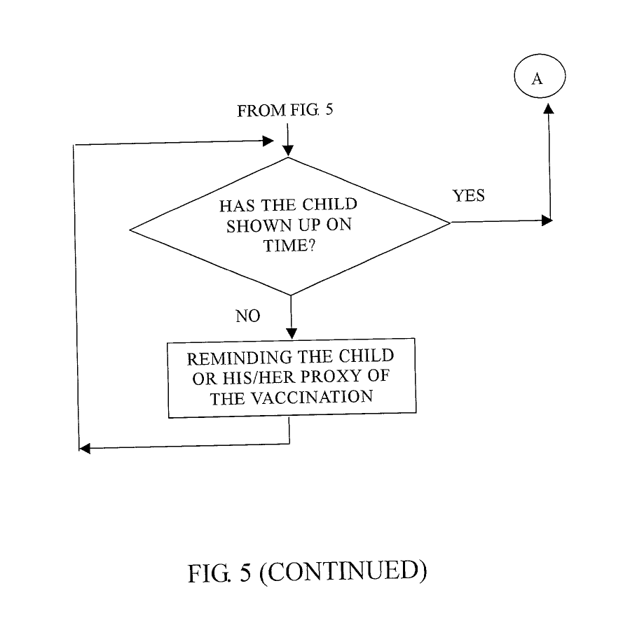

In still another embodiment, the method of the present invention includes setting up the vaccination database and watching a child to be vaccinated in time. As shown in FIG. 5, the method of this embodiment first decides whether a child receiving a physical examination is a new client (child) or not. A new child is required to enter the basic data before deciding how many kinds of vaccines are to be injected (deciding “n”, n is zero or positive integer). Each of the “n” vaccinations is then injected and recorded, and the time for next vaccination thereof is determined in sequence, until all the “n” vaccinations are injected. The steps thereafter comprises notifying the child or his/her proxy in advance the determined time; checking whether the child has shown up according to the determined time; reminding the child or his/her proxy to be vaccinated, if the answer is “NO” ; and returning to the step of determining “n”, if the answer is “YES”.

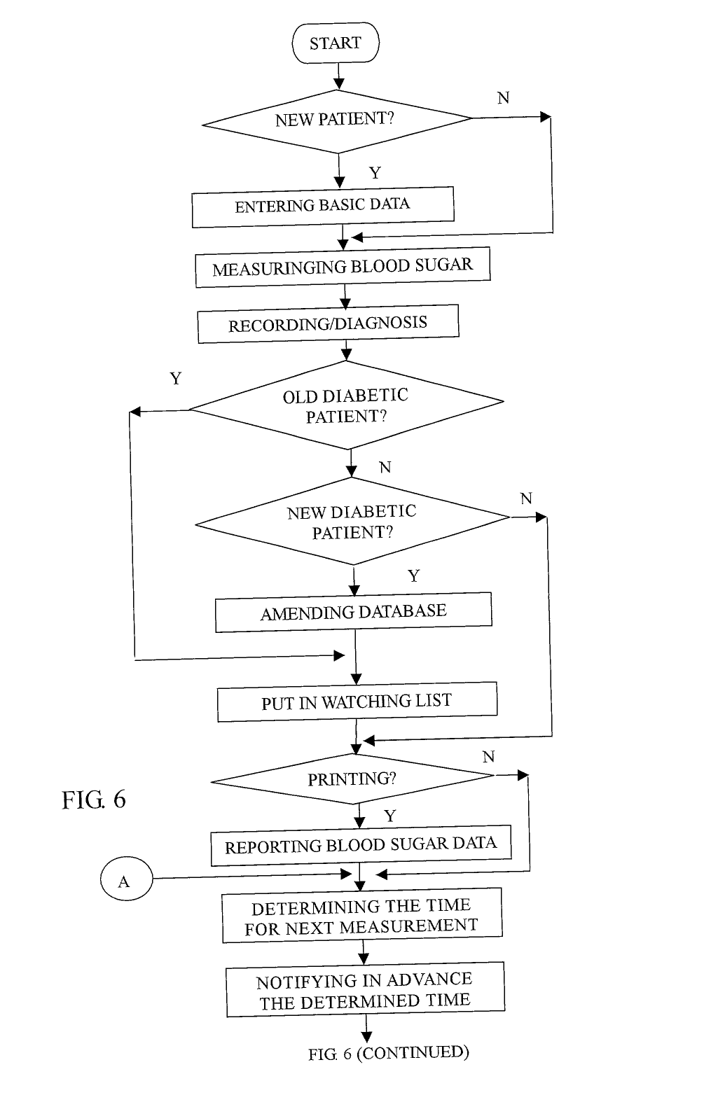

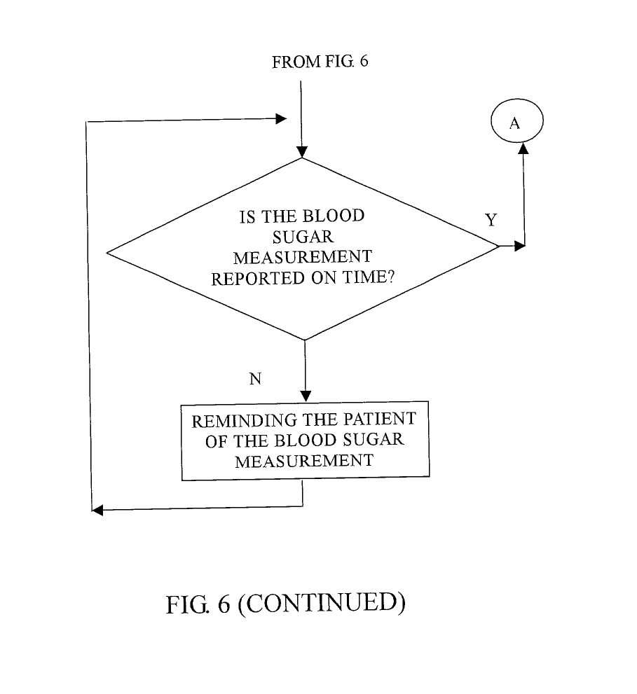

In a further embodiment, the method of the present invention includes setting up the blood sugar database and watching the blood sugar of a diabetic patient. As shown in FIG. 6, the method of this embodiment contains three determination formulas: “whether this is a new client (patient)?”, “whether this is an old diabetic patient?”, and “whether this is a new diabetic patient?”. The method according to this embodiment first decides whether a person taking a blood sugar measurement is a new client (patient) or not. A new patient is required to enter the basic data before the measurement. The blood sugar measurement is then recorded and is used for diagnosis. The status of the client will be checked to decide whether the client is an old diabetic patient or not. If the client is not an old diabetic patient, he/she will be decided as a new diabetic patient or not based on the blood sugar data. If the answer is “Yes”, the status of the client will be changed to a diabetic patient and put into the watching list. If the answer is “No”, the client will not be put into the watching list. If the client is an old diabetic patient, he/she will be put in the watching list directly. The method will then decide whether the blood sugar data of the client is to be printed, so that the client can receive the printing report which may include the historical data of blood sugar, the trend diagram of blood sugar, etc. The steps thereafter comprise determining the time for next measurement; notifying the patient in advance the determined time; checking whether the patient reports his/her blood sugar according to the determined time; reminding the patient of the blood sugar measurement, if the answer is “No”, and returning to the step of determining the time for next measurement, if the answer is “Yes”.

The method and system according to the present invention can also be applied to the prediction the period of a female and interactions thereof”, details of which are disclosed in the Taiwan patent application No. 89111814. The present invention preferably comprises at least two or more of the above-mentioned databases of blood pressure, blood sugar, vaccination and period of a female, etc.

What is claimed is:

1. A method of watching a person to be diagnosed/treated in time comprising the following steps carried out in a computer system:
a) determining time for a person to be diagnosed/treated according to medical criteria on his/her medical data recorded in a medical database of persons;
b) notifying said person to be diagnosed/treated according to the determined time in advance the determined time;
c) reminding said person of the determined time if said computer system should fail to receive a confirmation of said person's diagnosis/treatment after the determined time; and
d) entering diagnosis/treatment data of said person into the medical database of persons, if said computer system receives the confirmation.

2. The method as claimed in claim 1, in which said diagnosis/treatment to be applied to the person is health examination, and the medical database is a database of health examination data.

3. The method as claimed in claim 1, in which said reminding is once per day.

4. The method as claimed in claim 1, in which said notifying or said reminding step adopt a WAP system.

5. A system of watching a person to be diagnosed/treated in time comprising:
a database server;
a network server; and
communication means;
wherein said database server is built-in with a medical database and with a software, so that
A) said database server determines time for a person to be diagnosed/treated according to his/her medical data recorded in said medical database;
B) said network server and said communication means notify said person to be diagnosed/treated according to the determined time in advance the determined time; and
C) said network server and said communication means remind said person of the determined time for the diagnosis/treatment if said network server should fail to receive a confirmation of said person's diagnosis/treatment after the determined time.

6. The system as claimed in claim 5, in which said diagnosis/treatment to be applied to the person is health examination, and the medical database is a database of health examination data.

7. The system as claimed in claim 5, in which said reminding is once per day.

8. The system as claimed in claim 5, in which said communication means comprises a WAP system.
